(19) United States
(12) Patent Application Publication
(10) Pub. No.: US 2007/0040053 A1
(43) Pub. Date: Feb. 22, 2007

(54) Fuel injection apparatus for internal combustion engine

(75) Inventor: Kenji Date, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/505,305

(22) Filed: Aug. 17, 2006

(30) Foreign Application Priority Data
Aug. 18, 2005 (JP) 2005-237810

(51) Int. Cl. F02M 63/00

(52) U.S. Cl. 239/533.2

(57) ABSTRACT

A fuel injection valve has a sac chamber filled with high-pressure gaseous fuel, an injection hole communicated with the sac chamber, and a nozzle needle that slidably moves to allow and interrupt a supply of the high-pressure gaseous fuel into the sac chamber. The fuel injection valve performs an injection of the high-pressure gaseous fuel directly into a combustion chamber of the internal combustion engine in accordance with a movement of the nozzle needle. The injection hole has an outlet portion with a divergently formed inner surface as coming toward an outlet end of the injection hole. The driving portion controls the movement of the nozzle needle to change a sac chamber pressure of the high-pressure gaseous fuel in the sac chamber so as to switch a jet flow speed of the high-pressure gaseous fuel injected through the injection hole between a subsonic speed and a supersonic speed.

### CROSS REFERENCE TO RELATED APPLICATION

This application is based upon and claims the benefit of priority of Japanese Patent Application No. 2005-237810 filed on Aug. 18, 2005, the content of which is incorporated herein by reference.

### FIELD OF THE INVENTION

The present invention relates to a fuel injection apparatus for an internal combustion engine, which injects high-pressure gaseous fuel from a fuel injection valve into a cylinder of the internal combustion engine.

### BACKGROUND OF THE INVENTION

For practical uses of alternative fuels in place of conventional liquid fossil fuels, internal combustion engines for gaseous fuels are under development. The gaseous fuels such as hydrogen gas, natural gas, petroleum gas, etc. are expected to perform high combustion efficiency. Combustions of gaseous fuels, especially hydrogen, however, have issues including relatively large heat loss on a wall surface of a cylinder of the internal combustion engine, and emission of NOx. The relatively large heat loss is due to a short fire quenching distance to which combustion flame extends. The emission of NOx is caused by the rapid combustion speed so that the air-fuel mixture reaches combustion temperature on a condition of large fuel density.

U.S. Pat. No. 5,413,075 and its counterpart JP-H06-241077-A (hereinafter referred to as Patent document 1) and JP-H03-000967-A (hereinafter referred to Patent document 2), for example, disclose fuel injection apparatuses for solving this problem.

Patent document 1 discloses a method to switch fuel injection modes to form relatively small quantity of NOx, in accordance with an excess-air ratio λ of burning air-fuel mixture. In this method, a suitable mode is selected from a premixture operation mode and a direct-injection operation mode, based on a threshold value λ0 (1<λ0<2) to form less NOx, so that the emission of NOx is decreased.

However, in the method according to Patent document 1, when a fuel injection is performed in an early timing in the premixture operation mode, the jet flow has too large jet momentum with respect to a decreased in-cylinder pressure. Therefore, the jet flow can be spread over the wall surface of the cylinder, and this shape of the jet flow can increase the heat loss. If a shape of an injection hole and an injection condition are configured to form the jet flow having small jet momentum to solve this problem, the in-cylinder pressure can be too high in the direct-injection operation mode. Thus, the mixture of fuel and air can be insufficient, so as to decrease a combustion efficiency or to increase the emission of NOx.

It is considered to perform multiple fuel injections during one combustion cycle in order to reduce the production of NOx. The production quantity of NOx becomes small when the excess-air ratio λ is 2 or greater and when λ is 1.1 or smaller. Therefore, it is considered to inject the fuel directly into a burning flame during a combustion having the excess-air ratio λ of 2, so as to make the combustion have the excess-air ratio λ of 1.1 or smaller. However, even in this method, fuel injections are performed in the early timing and in a timing close to a top dead center (TDC), so that substantially the same adverse effects as in Patent document 1 can occur.

Patent document 2 discloses a fuel injection nozzle for a liquid fuel (gasoline or light oil) for promoting a mixture of fuel and air. The fuel injection nozzle has an injection hole in which a straight portion and a divergently tapered portion are combined to promote the mixture of fuel and air.

The divergent injection hole according to Patent document 2 forms a fuel jet flow having a divergent shape so as to promote the mixture of fuel and air and to realize steady fuel jet flow. However, a regularly convergent shape of the fuel jet flow may not mix fuel and air sufficiently when in-cylinder pressure is high.

As described above, the combustion states of fuel injection apparatuses for gaseous fuels, which are associated with the present invention, vary much, depending on in-cylinder pressures of the internal combustion engines. Thus, it is difficult to keep optimum jet flow states regularly in accordance with driving states of internal combustion engines.

In this regard, Laval nozzles are used in rocketry field for jetting a burnt combustion gas. As shown in FIG. 10, Laval nozzle has a shape that includes a convergent nozzle portion, a throat portion in which a cross-sectional area of the nozzle is minimized, and a divergent nozzle portion from an inlet to an outlet of the nozzle (injection hole), so that the combustion gas reaches the sonic speed in the throat portion. It is important in rocket field to generate a large propelling force. Thus, the shapes of Laval nozzles for jetting the burnt combustion gas are changed in accordance with an outside pressure that varies from one atmospheric pressure to a vacuum pressure in the outer space beyond earth's atmosphere, so as to generate a supersonic maximum jet speed.

However, in internal combustion engine field associated with the present invention, the fuel injected out of the nozzles can collide with the wall surface of the cylinder. Therefore, it is not always necessary to accelerate the jet flow speed of the fuel injection to the supersonic speed, depending on driving states of the internal combustion engines. Further, in contrast to rocket nozzles that are in steady jet flow states during several minutes to several hours, the nozzles of internal combustion engines are in nonsteady jet flow states, for internal combustion engines repeat valve-opening/closing operations at intervals of several milliseconds, and driving states of internal combustion engines changes much as from an idling time to an overtaking/climbing time, etc. Diameters of rocket nozzles range from several centimeters to several meters, so that rocket nozzles allow spaces to locate variable mechanisms therein. Contrastively, injection hole diameters of single hole nozzles ranges in several millimeters, and injection hole diameters of multi-hole injection nozzles ranges in one hundred micrometers order. Therefore, the fuel injection nobzzles have difficulty in processing and do not allow spaces to locate variable mechanisms therein. Furthermore, in rocketry field, the outside pressure is quite low while rockets are traveling in the outer space, and the outside pressure is one atmospheric pressure at maximum. Contrastively, when fuel is directly injected into cylinders of internal combustion engines, the outside pressure into which the fuel is injected ranges approximately 2 MPa to 3 MPa.

As described above, demanded jet flow speed, jet flow state, nozzle's scale and outside pressure in the internal combustion engine field, which is associated with the present invention, differ much from those in rocketry field. Thus, it is not possible to adopt the technique in rocketry field in a straightforward manner into the injection holes of the fuel injection nozzles for internal combustion engines.

### SUMMARY OF THE INVENTION

The present invention, in view of the above-described issue, has an object to provide a fuel injection apparatus for an internal combustion engine, which injects gaseous fuel directly into a cylinder of the internal combustion engine, forming optimum fuel jet flow shapes in accordance with in-cylinder pressures. Specifically, the present invention relates to the fuel injection apparatus that can form a subsonic fuel jet flow when the in-cylinder pressure is low and a supersonic fuel jet flow when the in-cylinder pressure is high, so as promote a fuel distribution and a mixture of fuel and air, and reduce the heat loss and the emission of NOx.

The fuel injection apparatus for an internal combustion engine includes a fuel injection valve, a high-pressure gaseous fuel supply passage and a driving portion.

The fuel injection valve has a sac chamber filled with high-pressure gaseous fuel, an injection hole communicated with the sac chamber, and a nozzle needle that slidably moves to allow and interrupt a supply of the high-pressure gaseous fuel into the sac chamber. The fuel injection valve performs an injection of the high-pressure gaseous fuel directly into a combustion chamber of the internal combustion engine in accordance with a movement of the nozzle needle. The injection hole has an outlet portion with a divergently formed inner surface as coming toward an outlet end of the injection hole.

The high-pressure gaseous fuel supply passage supplies the high-pressure gaseous fuel into the sac chamber. The driving portion controls the movement of the nozzle needle to change a sac chamber pressure of the high-pressure gaseous fuel in the sac chamber so as to switch a jet flow speed of the high-pressure gaseous fuel injected through the injection hole between a subsonic speed and a supersonic speed.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1 is a diagram schematically showing an entire configuration of a fuel injection apparatus for an internal combustion engine according to an embodiment of the present invention;

FIG. 2A is a cross-sectional view showing a fuel injection valve in the fuel injection apparatus according to the embodiment;

FIG. 2B is an enlarged cross-sectional view showing a leading end portion of a nozzle of the fuel injector shown in FIG. 2A;

FIG. 3A is a cross-sectional view showing the leading end portion of the nozzle when a needle lift height is small;

FIG. 3B is a cross-sectional view showing the leading end portion of the nozzle when the needle lift height is large;

FIG. 4 is a diagram schematically showing an injection hole used in an experiment for investigating a jet travel and a jet angle relative to a shape of the injection hole;

FIG. 5A is a diagram schematically showing the jet travel investigated by the experiment;

FIG. 5B is a graph showing the jet travel investigated by the experiment when a sac chamber pressure is low;

FIG. 5C is a graph showing the jet travel investigated by the experiment when the sac chamber pressure is high;

FIG. 6A is a diagram schematically showing the jet angle investigated by the experiment;

FIG. 6B is a graph showing the jet angle investigated by the experiment when the sac chamber pressure is low;

FIG. 6C is a graph showing the jet angle investigated by the experiment when the sac chamber pressure is high;

FIG. 7 is a graph showing an injection hole inlet pressure and an opening area relative to a needle lift in the fuel injector;

FIG. 8 is a diagram showing a driving pulse, the needle lift, the injection hole inlet pressure and a jet flow shapes in a multiple fuel injection performed by the fuel injection apparatus according to the embodiment;

FIG. 9 is a diagram showing the driving pulse, the needle lift, the injection hole inlet pressure and the jet flow shapes in a needle lift-regulating injection performed by the fuel injection apparatus according to the embodiment;

FIG. 10 is a diagram showing a jet flow speed and a pressure ratio of an upstream and downstream pressures of the injection hole relative to a shape of Laval nozzle; and

FIG. 11 is a graph showing a jet flow speed of gaseous fuel and liquid fuel relative to a sac chamber pressure.

### DETAILED DESCRIPTION OF PREFERRED EMBODIMENTS

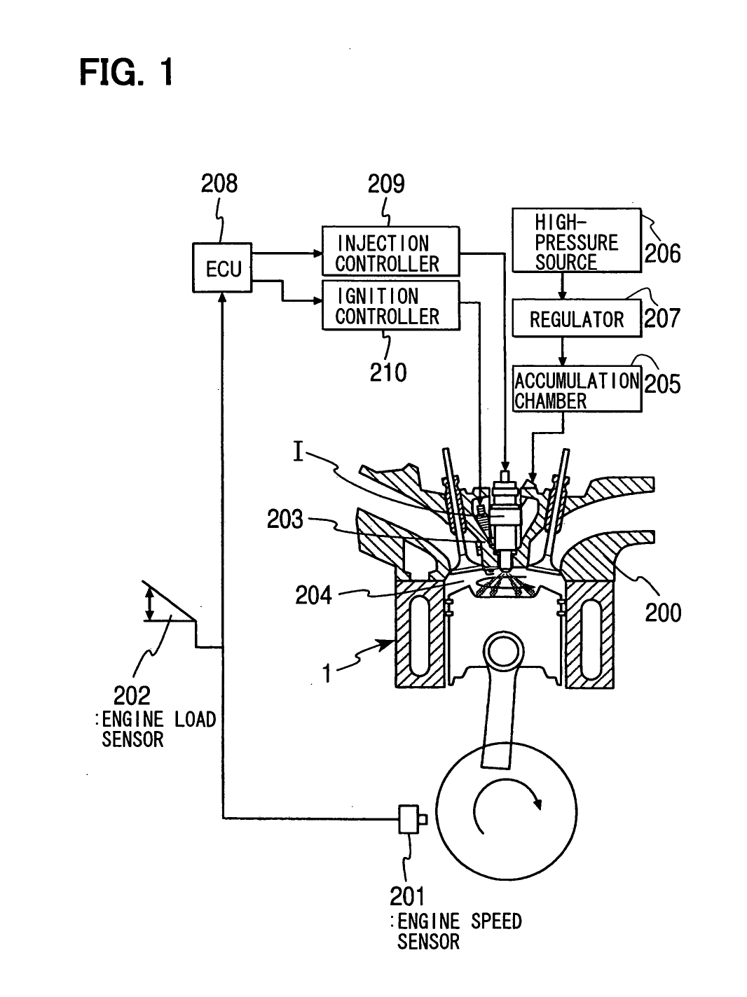

A fuel injection apparatus according to an embodiment of the present invention is described in the following, referring to FIGS. 1 to 8. FIG. 1 schematically depicts an entire configuration of the fuel injection apparatus for a multi-cylinder internal combustion engine 1. The internal combustion engine 1 is provided with a fuel injection valve I and an igniter 203, which are installed on an engine head 200, so as to ignite mixture gas of high-pressure gaseous fuel, which is jet directly into a cylinder 204, and air. Hydrogen, compressed natural gas (CNG), etc. are suitably used as the gaseous fuel. The gaseous fuel, which is to be supplied to the fuel injection valve I, is sent from a high pressure source 206 such as a high-pressure pump, a compressed-gas cylinder, etc., via a pressure regulating device 207, which regulates a pressure of the gaseous fuel to a specified value, to an accumulation chamber 205, which has a specific volume and is used commonly for every cylinders of the internal combustion engine 1.

An ECU 208 calculates injection timings, injection quantities, injection frequency, and ignition timings, in accordance with an engine's rpm detected by an engine rpm detecting device 201 and an engine's load condition detected by an engine load detecting device 202. Then, the ECU 208 sends signals, which correspond to the injection timings, the injection quantities and the injection frequency to an ignition valve control unit 209. When the fuel injection valve I is driven, the high-pressure gaseous fuel is supplied from the accumulation chamber 205, injected into the cylinder 204 and then mixed with the air by an airflow in the cylinder 204 and a jet flow momentum of the high-pressure gaseous fuel. The ECU 208 also sends a signal, which corresponds to the ignition timings, to an ignition control unit 210 so that the igniter 203 forms an ignition source, in order to burn this air-fuel mixture. In FIG. 1 is shown only one cylinder. The other cylinders of the internal combustion engine 1 have substantially the same constructions as shown in FIG. 1. One fuel injection valve 1 is provided for each cylinder of the internal combustion engine 1.

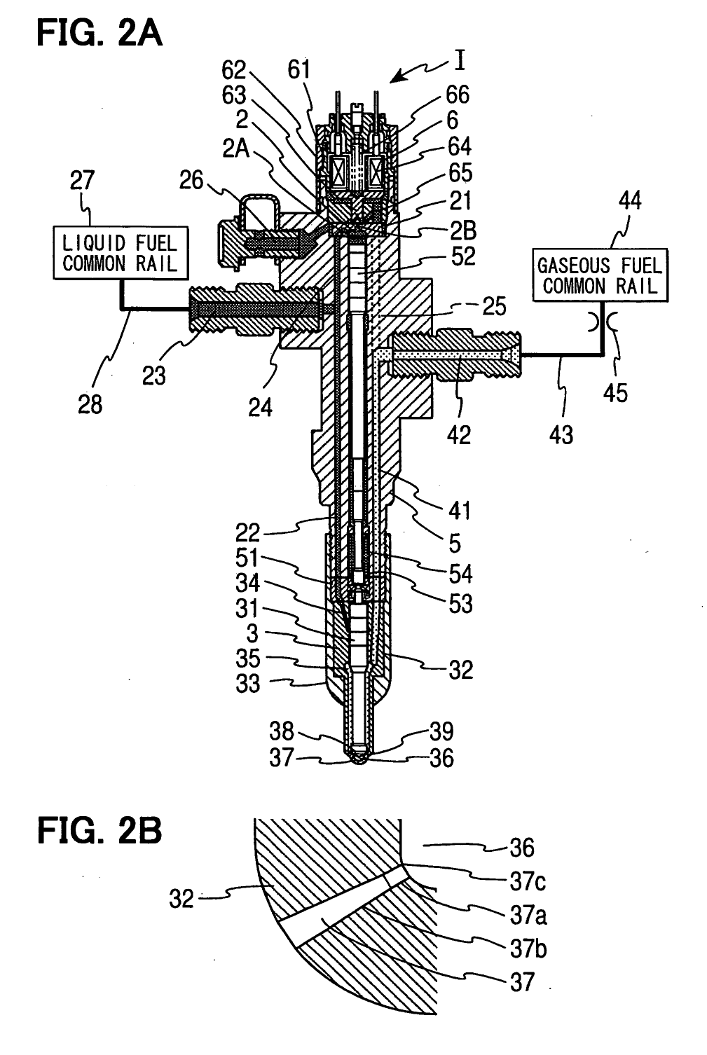

FIG. 2A depicts a longitudinal cross-section of the fuel injection valve I according to the present embodiment. On a right side in FIG. 2A is shown a supply path of the high-pressure gaseous fuel that is supplied from a high-pressure gas common rail 44, which corresponds to the accumulation chamber 205 in FIG. 1, to a nozzle 3 on a leading end of the fuel injection valve I. On a left side in FIG. 2A is shown a supply path of a hydraulic liquid that is supplied from a liquid common rail 27 to a control chamber 2 so as to drive the nozzle 3. In the present embodiment, a valve-closing operation of a nozzle needle 31 is performed by using the hydraulic liquid, which is different from the fuel to be injected, that is, different from the high-pressure gaseous fuel, and a valve-opening operation of the nozzle needle 31 is performed by using a pressure of the high-pressure gaseous fuel, so as to perform an ON/OFF control of a pressure in the control chamber 2.

The above-mentioned construction, which is provided with the control chamber 2 for exerting a valve-opening pressure onto the nozzle needle 31, is known as a nozzle-driving method of conventional fuel injection valves for injecting liquid fuel. This valve-opening method is applied to the fuel injection valve I to regulate the pressure in the control chamber 2 with the hydraulic liquid, so as to control the fuel injection operations. Either of hydraulic oil or liquid fuel such as light oil can be used as the hydraulic liquid.

Firstly, a principal construction of the fuel injection valve I and the supply path of the hydraulic liquid are described in the following. As shown in FIG. 2A, the fuel injection valve I includes an injector body 5, the nozzle 3 that is located on a lower side of the injector body 5 so as to interpose a tip gasket 51 therebetween, and an electromagnetic valve 6 that is installed onto an upper end opening 6f the injector body 5 so as to interpose a plate member 21 therebetween. The electromagnetic valve 6 acts as an electric switching valve. A retaining nut 33 fastens the nozzle 3 and the tip gasket 51 integrally to the injector body 5. Another retaining nut 62 fastens the electromagnetic valve 6 integrally to the injector body 5.

The injector body 5 has substantially cylindrical shape. In a cylindrical hole of the injector body 5 is slidably installed a control piston 52. The control chamber 2 is formed on an upper end side of the control piston 52. In a cylindrical wall portion of the injector body 5 extend a high-pressure liquid passage 22 and a low-pressure liquid return passage 25 in an axial direction (in a vertical direction of the drawing), respectively as shown on the left and right sides of FIG. 2A. The high-pressure liquid passage 22 and the low-pressure liquid return passage 25 are located on both sides of the control piston 52. The high-pressure liquid passage 22 serves as the supply path of the hydraulic liquid. A part of the low-pressure liquid return passage 25 are not exposed on the section shown in FIG. 2A. The high-pressure liquid passage 22 is communicated to a liquid inflow pipe 23, which protrudes upward in a slanting direction from an upper side portion of the injector body 5, to be connected via a liquid supply pipe 28 to a liquid common rail 27 that accumulates a liquid fuel at a specific high-pressure. An upper end of the low-pressure liquid return passage 25 is communicated via an inside of an liquid outflow pipe 26, which protrudes from the upper end portion of the injector body 5, to be communicated to a liquid fuel tank (not shown).

The nozzle 3 slidably supports the nozzle needle 31 in a longitudinal hole that is formed in a nozzle body 32 in the axial direction. The nozzle needle 31 has a stepped shape. An upper end portion of the nozzle needle 31 is coupled to a lower end portion of the control piston 52 so that the nozzle needle 31 moves integrally with the control piston 52. A return spring 53, which is installed in a spring chamber 54 formed around the lower end portion of the control piston 52, biases the nozzle needle 31 downward. A lower end of the high-pressure liquid passage 22 is communicated to a high-pressure liquid passage 34 that is formed in the nozzle body 32, so that the high-pressure liquid passage 34 supplies lubricating oil to a guide portion 311 of the nozzle needle 31, in which a diameter of the nozzle needle 31 is extended. A lower end of the low-pressure liquid return passage 25 is communicated to the spring chamber 54, so as to collect leakage oil that is leaked from respective portions of the fuel injection valve I and to discharge the leakage fuel through the liquid outflow pipe 26.

In the upper end opening of the injector body 5 is installed the plate member 21 so as to close the cylindrical hole in which the control piston 52 slides. The control chamber 2 is defined by an upper end surface of the control piston 52, an interior wall of the cylindrical hole on an upper side than the control piston 52, and a depressed portion that is formed in a central portion on a lower end surface of the plate member 21. An inlet orifice 2B communicates the control chamber 2 at all times to a high-pressure passage 24 that is branched off the high-pressure liquid passage 22, so that the pressure in the control chamber 2 acts downward via the control piston 52 to the nozzle needle 31. Further, an outlet orifice 2B communicates the control chamber 2 to the low-pressure liquid return passage 25. The electromagnetic valve 6 performs a connection and an interruption between the control chamber 2 and the low-pressure liquid return passage 25, so as to increase and decrease the pressure in the control chamber 2. In this manner, a supply path of the hydraulic liquid extends from the liquid inflow pipe 23 via the high-pressure liquid passage 22, the high-pressure passage 24, and the inlet orifice 2A to the control chamber 2.

The electromagnetic valve 6 includes a cylindrical solenoid 64 and a control valve 63 that are installed in a solenoid body 61. The control valve 63 has an armature having a T-shaped cross-section that faces a lower end surface of the solenoid 64, and a ball valve that is supported in a hemispherical depressed portion that is formed in a leading end portion of the armature. Around the leading end portion of the armature are provided a low-pressure passage 65 that communicates the outlet orifice 2B and the liquid return passage 25 to each other. When the electromagnetic valve 6 is not energized, the control valve 63 is biased downward by a spring that is installed in the cylinder of the solenoid 64, so that the ball valve closes the outlet orifice 2B of the control chamber 2.

In the following is described the supply path of the high-pressure gaseous fuel to an injection hole 37, which is formed in the leading end of the nozzle 3, referring to FIGS. 2A, 2B. As shown in FIG. 2A, an annular space of a nozzle chamber 35 is formed between a middle portion of the nozzle needle 31 and an inner circumferential wall of the nozzle body 32. A sac chamber 36 is formed below the nozzle chamber 35. The injection hole 37 is formed so as to penetrate an outer wall of the sac chamber 36. In the cylindrical wall portion of the injector body 5 extends a high-pressure gas passage 41 in the axial direction (in the vertical direction of the drawing), as shown on the right side of FIG. 2A. The high-pressure gas passage 41 is communicated to a high-pressure gas inflow pipe 42, which protrudes from the upper side portion of the injector body 5, to be connected via a high-pressure gas pipe 43 and an orifice portion 45 to a high-pressure gaseous fuel common rail 44. The high-pressure gaseous fuel common rail 44 acts as an accumulator of the high-pressure gaseous fuel. The supply path of the high-pressure gaseous fuel includes the respective passages from the high-pressure gas inflow pipe 42 to the injection hole 37.

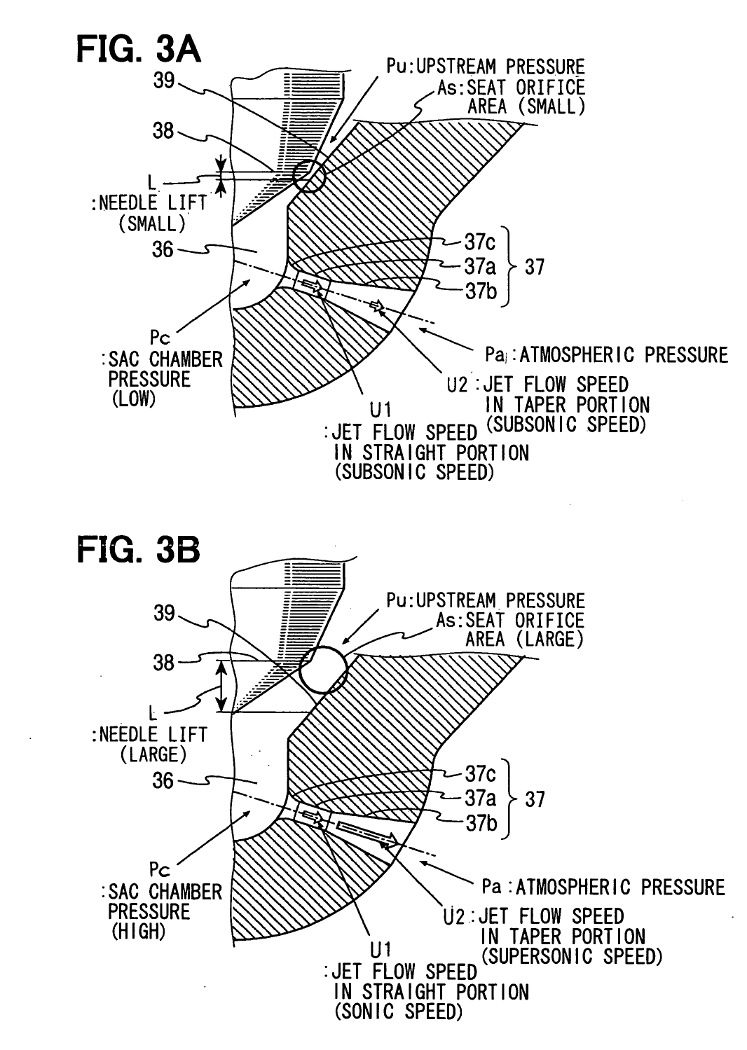

As shown in FIG. 2B, the injection hole 37 includes a straight portion 37a on an upstream side close to sac chamber 36, and a tapered portion 37b on a downstream side of the straight portion 37b. A diameter of the injection hole 37 is generally constant and minimized in the straight portion 37a. The tapered portion 37b is an outlet portion that opens on an outer wall surface of the outer wall of the nozzle body 32. A diameter of the injection hole 37 gradually increases in the tapered portion 37b as coming closer to the outer wall surface of the nozzle body 32. At an inlet portion that communicates the sac chamber 36 and the straight portion 37a is provided a rounded portion 37a so as to flow the gaseous fuel smoothly from the sac chamber 36 into the injection hole 37. A plurality of the injection holes 37 are arranged to surround a central axis of the nozzle body 32. As shown in FIGS. 2A, 3A, 3B, a conically shaped seat surface 39 is formed on a boundary between the sac chamber 36 and the nozzle chamber 35. A needle head 38, which is formed on a leading end of the nozzle needle 31, seats onto the seat surface 39 so as to interrupt a communication between the sac chamber 36 and the nozzle chamber 35 and to stop the fuel flow out of the injection holes 37.

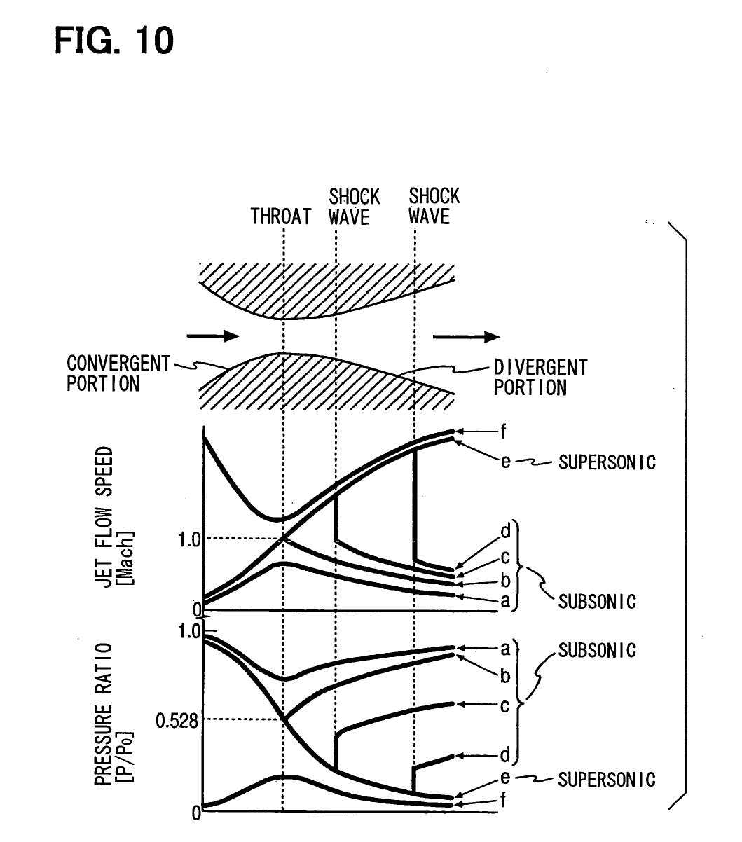

In the following is described a difference of a shape of the injection hole 37 in the present embodiment and the shape of above-mentioned Laval nozzle for rocketry. As shown in FIG. 10, the convergent portion, the throat portion and the divergent portion are shaped by a smoothly curved surface in Laval nozzle. Contrastively, the injection hole 37 in the present embodiment has the following shape so as to be easily processed and to serve substantially the same effect as the Laval nozzle. The inlet portion of the injection hole 37, which corresponds to the convergent portion of Laval nozzle, is rounded to have a rounding radius R of 0.01 millimeters to 0.5 millimeters to be the rounded portion 37c, as injection holes' inlet portions of diesel nozzles. The rounding portion 37c is processed by fluid polishing process, that is, a cutting process using sandblasted abrasive grains. The minimum diameter portion, which corresponds to the throat portion of Laval nozzle, is formed to be a straight hole that has a uniform diameter and a length of several hundreds micrometers, to be the straight portion 37a. The diameter of the minimum diameter portion is important for controlling a jet flow speed and an injection quantity of gaseous fuel, so that the minimum diameter portion is formed as the straight portion 37a that is easily processed with fine quality. The divergent portion is formed as the tapered portion 37b that has a regular taper angle of several degrees to a few tens degrees to gradually increase the diameter as coming toward an exit, so as to be easily processed.

In the following is described an action of the fuel injection valve I having the above-described construction. When the ECU 208 shown in FIG. 1 sends a valve-opening command to the ignition valve control unit 209 to drive the fuel injection valve I, firstly a driving current is applied to the solenoid 64 of the electromagnetic valve 6 shown in FIG. 2A, so as to draw the control valve 63 upward against the biasing force of the spring 66 to open the outlet orifice 2B of the control chamber 2. In accordance with the valve-opening operation of the control valve 63, the high-pressure fuel in the control chamber 2 is discharged via the outlet orifice 2B and the low-pressure passage 65 to the liquid return passage 25. In this regard, a fluid passage area of the outlet orifice 2B, which regulates an outflow of the high-pressure fuel from the control chamber 2 to the low-pressure passage 65, is set larger than a fluid passage area of the inlet orifice 2A, which regulates an inflow of the high-pressure fuel from the high-pressure passage 24 to the control chamber 2. Accordingly, the pressure in the control chamber 2 decreases in accordance with the valve-opening operation of the control valve 63.

When the pressure in the control chamber 2 is decreased, a downward pushing force exerted onto the control piston 52 and the nozzle needle 31 decreases. Thus, a force, which is exerted upward onto the nozzle needle 31 by the high-pressure gaseous fuel in the nozzle chamber 35, becomes larger than a total force, which is exerted downward onto the nozzle needle 31 by the spring 53 and a decreased hydraulic liquid pressure in the control chamber 2. Accordingly, the nozzle needle 31 moves upward to lift the needle head 38 apart from the seat surface 39, so that the high-pressure gaseous fuel in the nozzle chamber 35 is flown into the sac chamber 36 and injected through the injection hole 37 into the combustion chamber of the internal combustion engine 1.

As shown in FIG. 3A, when a needle lift height L of the needle head 38 is relatively small as approximately 0.05 mm to 0.15 mm, for example, as in an initial injection time, etc., a seat orifice area As is smaller than a whole cross-sectional area of the injection hole 37. Thus, the fuel flow quantity passing through the seat portion is limited and a sac chamber pressure Pc does not increase. In this time, the sac chamber pressure Pc reaches a set pressure Ps that is higher than an atmospheric pressure Pa and lower than an upstream pressure Pu. The jet flow speed in the injection hole 37, which is on a downstream side of the sac chamber 36, especially the jet flow speed in the straight portion 37a depends on the set pressure Ps.

In this regard, in the above-mentioned Laval nozzle shown in FIG. 10, it is known that a jet flow state depends on a backpressure P on an outlet side of the convergent nozzle portion, on a condition that a pressure P0 on an upstream side of the convergent nozzle portion. When the backpressure P0 on the outlet side of the convergent nozzle portion is vacuum or sufficiently low, the jet flow, which is passed through the throat portion at the sonic speed, gradually increases Mach number of its speed as going toward the outlet so as to form a supersonic flow as indicated by a curve (e). When the backpressure P0 is relatively high, the jet flow speed does not reach a sonic speed in the throat portion as indicated by a curve (a), or the pressure of the jet flow decreases on a way of Laval nozzle to converge to the backpressure P0 on the outlet side of the convergent nozzle portion as indicated by curves (b) to (d)), not to form a supersonic flow.

In theory shown in FIG. 10, in the injection hole 37, when the pressure in the straight portion 37a decreases to approximately 0.53 time of the sac chamber pressure Pc, the jet flow speed in the straight portion 37a is considered to reach the sonic speed (approximately 1,350 m/sec in hydrogen). When the seat orifice area As is small and the sac chamber pressure Pc is low, the jet flow flows out of the injection hole 37 without decreasing the pressure to the approximately 0.53 time of the sac chamber pressure Pc. When the needle lift height L is small as shown in FIG. 3A, the jet flow speed in straight portion 37a is subsonic speed. Thus, the jet flow speed further decreases in the tapered portion 37b on the downstream side of the straight portion 37a as the cross-sectional area of the injection hole 37 increases, and the jet direction diverges in the tapered portion 37b, so as to form a jet flow having a wide jet angle and a relatively small jet momentum.

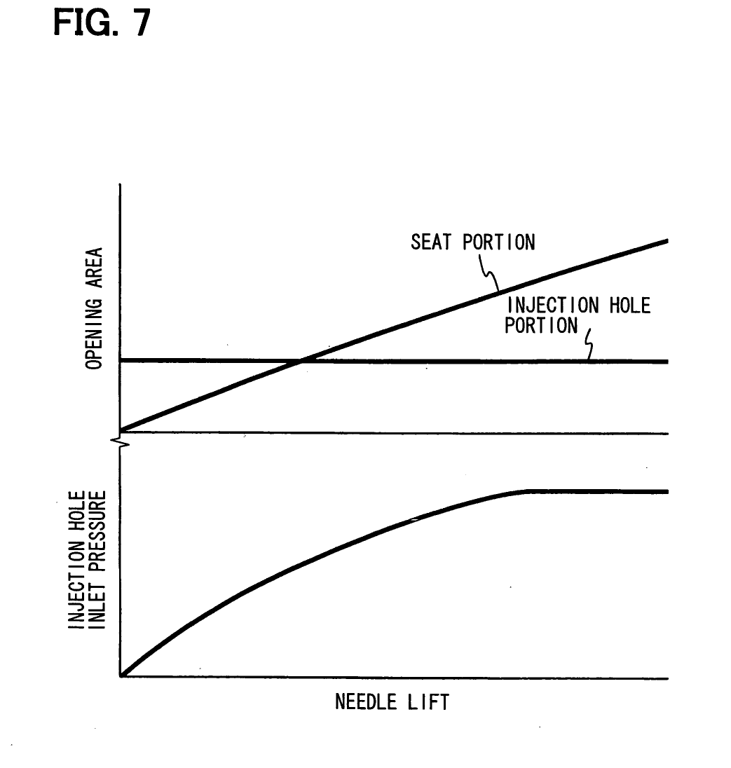

When a commanded injection period is relatively large so as to move the nozzle needle 31 upward beyond the above-mentioned small lift amount period, the fuel injection valve I performs the fuel injection in a large lift amount period as described below. The seat orifice area As, the whole cross-sectional area (opening area) of the injection hole 37, the sac chamber pressure Pc (injection hole inlet pressure) and the needle lift height L follow a relation as shown in FIG. 7, which is described below in detail.

As shown in FIG. 3B, when the needle lift height L of the needle head 38 is relatively large, for example, 0.3 millimeters or larger, the seat orifice area As is larger than the whole cross-sectional area of the injection hole 37. Thus, the fuel flow quantity passing through the seat portion is sufficient and a sac chamber pressure Pc increases. In this time, the sac chamber pressure Pc reaches the set pressure Ps that is higher than the atmospheric pressure Pa and lower than the upstream pressure Pu. As described above, the jet flow speed in the injection hole 37 depends on the set pressure Ps. As shown in FIG. 10, when the set pressure Ps exceeds a certain threshold value, the pressure of the jet flow in the straight portion 37a of the injection hole 37 is considered to decrease to approximately 0.53 time of the sac chamber pressure Pc so that the jet flow speed in the straight portion 37a reaches the sonic speed. When the atmospheric pressure Pa is low enough with respect to the pressure of the jet flow in the straight portion 37a, the jet flow is accelerated in the tapered portion 37b further from the sonic speed, to from a supersonic jet flow. It is possible to form the jet flow having a relatively large jet momentum in this manner.

When the fuel injection is stopped, the nozzle needle 31 is seated on the seat surface 39 in a reverse process as in the above-mentioned injection time. As described above, the jet flow shape can be changed by varying the needle lift height L (commanded injection period). Accordingly, it is possible to control the jet flow shape properly in accordance with respective states in the cylinder of the internal combustion engine 1.

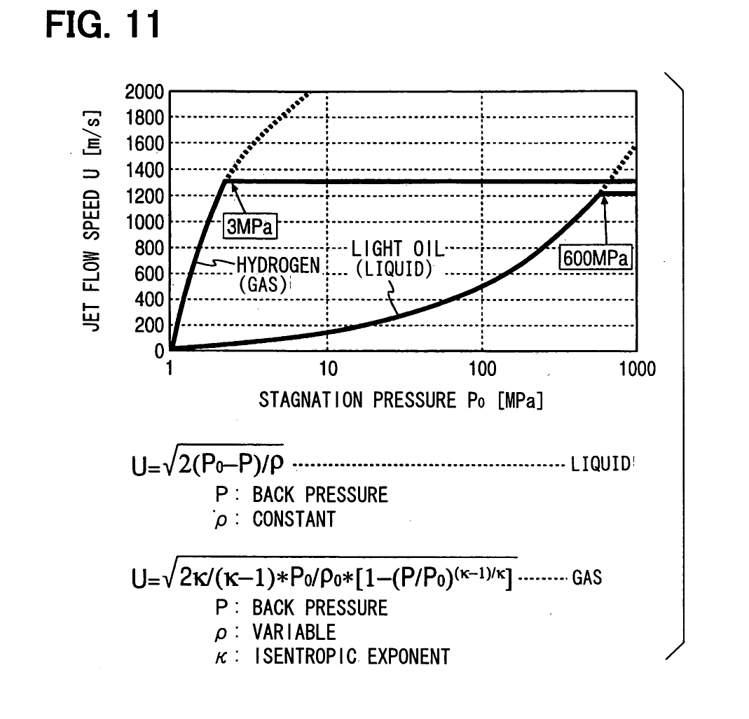

In the following is described a difference between a gaseous fuel injecting time and liquid fuel injecting time, referring to FIG. 11. Liquid fuel is generally noncompressible, that is, a density changes little even if a pressure varies. Contrastively, gaseous fuel is generally compressible, that is, a density changes much as a pressure varies. In view of this characteristic, FIG. 11 shows a jet flow speed U at which each of gaseous fuel (hydrogen) and liquid fuel (light oil), which is accumulated in an accumulator at a stagnation pressure, is injected in an ideal condition.

An equation (1) below is calculated from an equation (1)′, which is based on an energy conservation law of liquid fuel.
U²/2+P·ρ=const. (1)
U=\sqrt{2(P₀−P)/ρ} (1)
(ρ is constant)

An equation (2) below is calculated from an equation (2)′, which is based on an energy conservation law of gaseous fuel and gas state equation.
U²/2+k/(k−1)×P/ρ=const (2)′
U=\sqrt{2κ/(κ−1)×P₀/ρ₀×[1−(P/P₀)^{(κ=1)/κ}]} (2)
(ρ is variable)

In FIG. 11 is shown the pressure at which the jet flow speeds of gaseous fuel and liquid fuel respectively reach the sonic speed. As shown in FIG. 11, the sonic speed of gaseous fuel (hydrogen) is approximately 1,350 m/sec, and close to the sonic speed of liquid fuel (light oil). However, the stagnation pressure, at which the jet flow speed of gaseous fuel (hydrogen) reaches the sonic speed, is approximately 3 MPa, and much different from the stagnation pressure of approximately 600 MPa, at which the jet flow speed of liquid fuel (light oil) reaches the sonic speed. That is, in the case of liquid fuel as in the aforementioned Patent document 2, the jet flow speed does not reach the sonic speed, to form a divergent jet flow shape. Contrastively, in the case of gaseous fuel, it is relatively easy to perform the fuel injection in switching subsonic jet flows below 3 MPa and sonic jet flows of 3 MPa or higher.

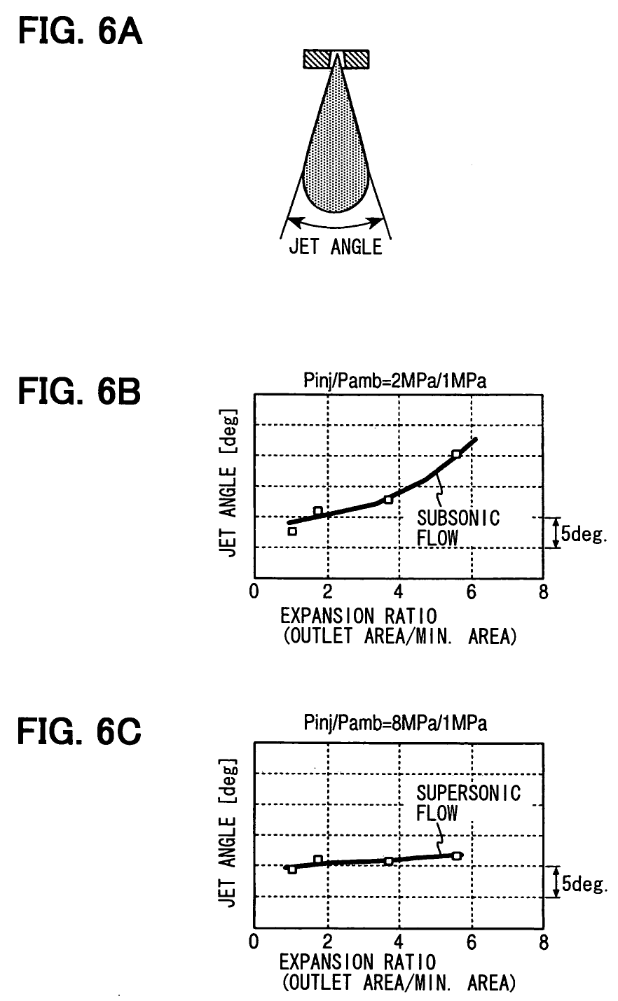

In the following is described an experiment and its result for investigating the above-described actions and effects, referring to FIGS. 5B, 5C, 6B, 6C. In the experiment, gaseous hydrogen is injected as fuel, so as to investigate the jet flow shape. Parameters in the experiment are an expansion ratio β(β=(outlet cross-sectional area)/(minimum cross-sectional area)=(fluid passage cross-sectional area at an opening end of the tapered portion 37b)/(fluid passage cross-sectional area of the straight portion 37a)), which is determined by a shape of the injection hole, and the injection pressure Pinj. The needle lift height is approximately 0.5 mm, to lift the nozzle needle quickly to the maximum lift height. Thus, the injection pressure Pinj and the set pressure Ps of the sac chamber pressure Pc are regarded substantially equal to each other. A relation between the expansion ratio β and the jet travel is investigated for each of four samples having the injection hole 37 with divergently tapered outlet portion with the minimum diameter Dm and the outlet diameter Do, which is varied as shown in the following table.

| | #1 | #2 | #3 | #4 |
|---|---|---|---|---|
| Minimum diameter Dm | 0.371 | 0.378 | 0.368 | 0.377 |
| Divergence angle α | 0 | 4 | 8 | 12 |
| Outlet diameter Do | 0.380 | 0.487 | 0.709 | 0.890 |
| Expansion ratio | 1.05 | 1.74 | 3.71 | 5.57 |

FIG. 5B depicts the result of the experiment when the injection pressure Pinj is set to 2 MPa, in which the jet flow becomes the subsonic flow without reaching the sonic speed in the above-mentioned theory. As shown in FIG. 5B, the jet travel, or the jet momentum of the jet flow gradually decreases as the expansion ratio β increases. FIG. 5C depicts the result of the experiment when the injection pressure Pinj is set to 8 MPa, in which the jet flow becomes the sonic flow to each the sonic speed in the above-mentioned theory. As shown in FIG. 5C, the jet travel, or the jet momentum of the jet flow gradually increases as the expansion ratio β increases. That is, by setting the expansion ratio β greater than 1 (for example, by setting as β=5) in contrast to a case of β=1 in a straight injection hole, it is possible to perform a switching of the jet flow speed range in the injection hole 37 in accordance with the lift amount. In this manner, it is possible to form the jet flow having a relatively small jet momentum when the sac chamber pressure Pc is low, and relatively large jet flow momentum when the sac chamber pressure Pc is high.

FIGS. 6B, 6C depicts the jet angle investigated by the experiment on the same condition as mentioned above. FIG. 6B depicts the result of the experiment when the injection pressure Pinj is set to 2 MPa, in which the jet flow becomes the subsonic flow without reaching the sonic speed in the above-mentioned theory. As shown in FIG. 6B, the jet angle gradually increases as the expansion ratio β increases. FIG. 6C depicts the result of the experiment when the injection pressure Pinj is set to 8 MPa, in which the jet flow becomes the sonic flow to each the sonic speed in the above-mentioned theory. As shown in FIG. 6C, the jet angle remains constant or slightly increases as the expansion ratio β increases. That is, by setting the expansion ratio β greater than 1 (for example, by setting as β=5) in contrast to the case of β=1 in a straight injection hole, it is possible to provide the jet flow with a widely divergent jet flow angle when the sac chamber pressure Pc is low and a small jet flow angle equivalent to the divergence angle of the straight injection hole when the sac chamber pressure Pc is high.

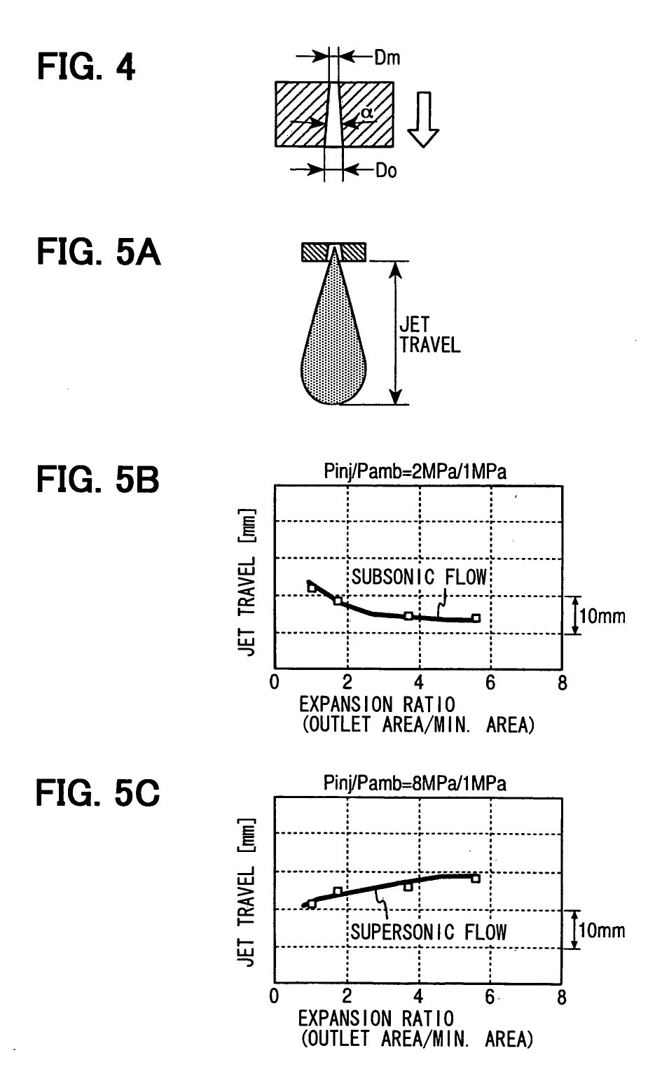

As described above, it is possible to minutely adjust the shape of the jet flow, especially the jet momentum and the jet angle in wide range, by setting the expansion ratio β, which depends on the shape of the injection hole 37, to a proper value and by using different jet flow speed ranges of subsonic range and supersonic range by controlling the sac chamber pressure Pc. A demanded shape of the jet flow can be formed by selecting the expansion ratio β desirably within a range of 2 to 6 (β=5, for example). It is desirable set a divergence angle α of the tapered portion 37b, which corresponds to the expansion ratio β as shown in FIG. 4, to be larger than 4 degrees. It is more desirable to set the divergence angle α within a range of 5 degrees to 15 degrees as demanded.

In the following is described a method to regulate the sac chamber pressure Pc in the sac chamber 36. FIG. 7 depicts a calculation result example of a seat orifice opening area property of the seat orifice and the sac chamber pressure relative to the needle lift height L in the nozzle 3. Generally, the seat orifice opening area is zero when the needle lift height L of the needle head 38 for opening and closing the nozzle 3 is zero, that is, when the fuel injection valve is closed, and the seat orifice opening area gradually increases as the needle lift height L increases. The opening area of the injection hole 37 is constant without depending on the needle lift height L. Accordingly, when the needle lift height L is a certain lift height or larger, solely the injection hole 37 acts as the orifice, so that the sac chamber pressure Pc remains constant. Contrastively, when the needle lift height L is a certain value or smaller, solely the injection hole 37 acts as the orifice, so that the sac chamber pressure Pc changes in accordance with the needle lift height L. Accordingly, by setting a fuel supply pressure to the fuel injection valve I to a value (8 MPa or higher, for example) that can form the supersonic jet flow, it is possible to change the jet flow shape characteristics in accordance with the needle lift height L. That is, it is possible to form the supersonic jet flow having a relatively large jet momentum when the needle lift height L is large and the sac chamber pressure Pc is high, and the subsonic jet flow having a relatively small jet momentum and a wide jet angle when the needle lift height L is small and the sac chamber pressure Pc is low.

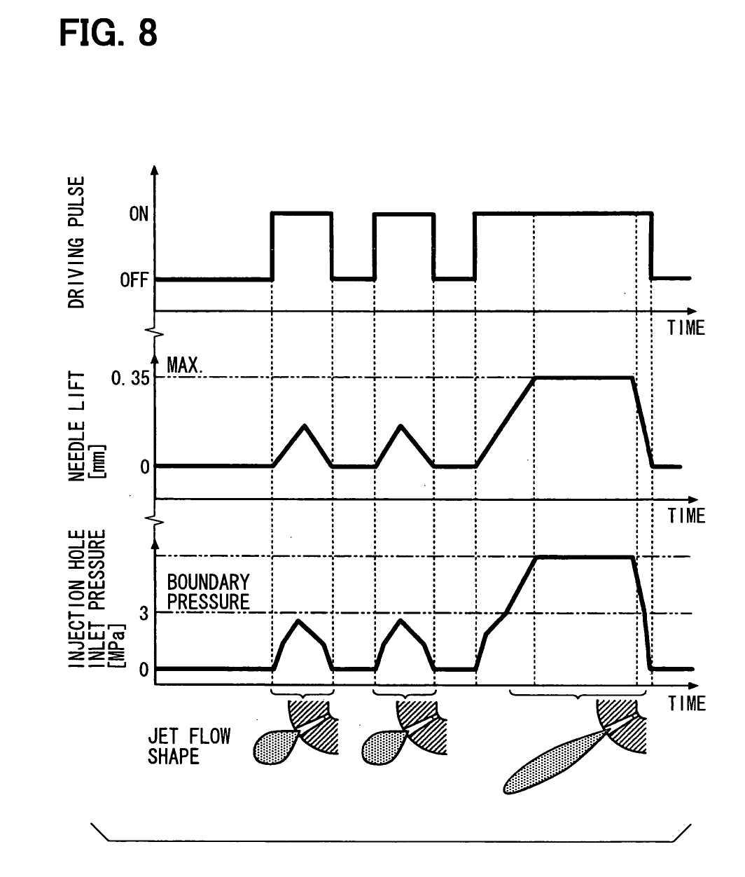

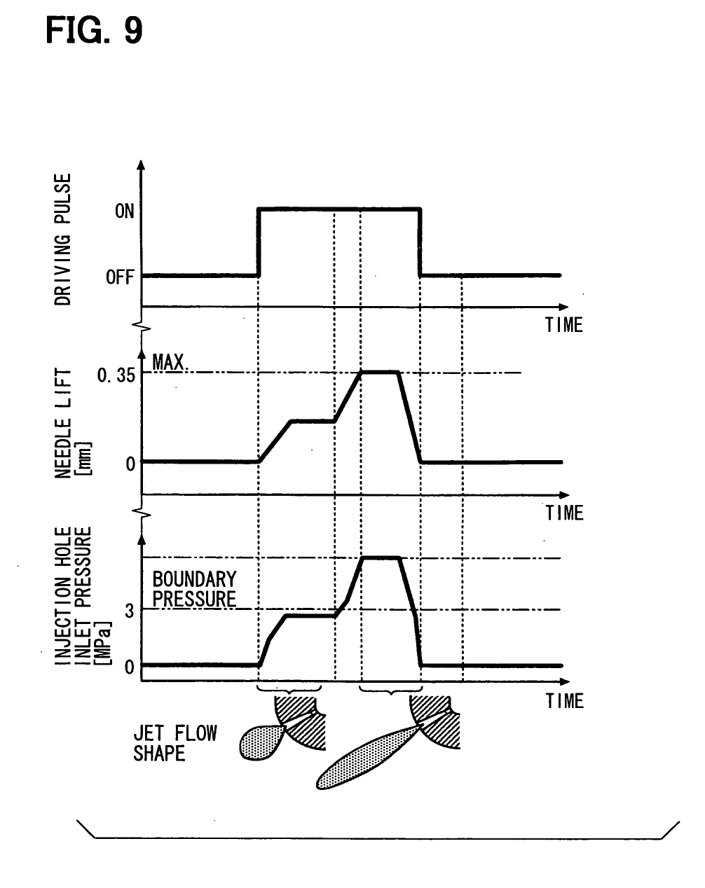

In the following is described a control method to change the jet flow shape characteristic during one engine cycle, referring to FIGS. 8, 9. FIG. 8 depicts an example of a multiple fuel injection. As shown in FIG. 8, when a driving pulse to the fuel injection valve I is short to perform a small quantity injection, the nozzle needle 31 moves up only to a relatively small lift height and then moves down. Accordingly, by properly setting the pulse period so that the needle lift height L is limited within the above-mentioned certain lift height, it is possible to form the subsonic jet flow having a relatively small jet momentum and a wide jet angle. Subsequently, by applying a relatively long driving pulse to the fuel injection valve I to perform a large quantity injection, the nozzle needle 31 moves up to the maximum lift height, so as to form the supersonic jet flow having a relatively large jet momentum. In this manner, it is possible to promote a mixture of the fuel and the air and to reduce a heat loss on a wall surface of the cylinder, so that a combustion state of the internal combustion engine 1 is improved.

FIG. 9 depicts an example of a needle lift-regulating fuel injection. When the fuel injection valve I is configured to be able to keep the nozzle needle 31 at a constant needle lift height temporarily during one fuel injection command, or during one driving pulse, the constant needle lift height is set to the above-mentioned certain lift height. Thus, it is possible to change the jet flow shape during one fuel injection. That is, the driving pulse forms a subsonic jet flow having a relatively small jet momentum and a wide jet angle in an initial stage of the fuel injection, and then forms a supersonic jet flow having the large jet flow momentum, so as to serve an effect substantially the same as in the above-mentioned multiple fuel injection shown in FIG. 8.

As described above, by the fuel injection apparatus according to the present invention, the high-pressure gaseous fuel directly injected into the cylinder forms the jet flow suitable for the condition in the cylinder, and the heat loss and the NOx emission of the internal combustion engine are reduced.

This description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fuel injection apparatus for an internal combustion engine comprising:
a fuel injection valve that has a sac chamber filled with high-pressure gaseous fuel, an injection hole communicated with the sac chamber, and a nozzle needle that slidably moves to allow and interrupt a supply of the high-pressure gaseous fuel into the sac chamber, the fuel injection valve being for performing an injection of the high-pressure gaseous fuel directly into a combustion chamber of the internal combustion engine in accordance with a movement of the nozzle needle, and the injection hole having an outlet portion with a divergently formed inner surface as coming toward an outlet end of the injection hole;
a high-pressure gaseous fuel supply passage that supplies the high-pressure gaseous fuel into the sac chamber; and
the driving portion that controls the movement of the nozzle needle to change a sac chamber pressure of the high-pressure gaseous fuel in the sac chamber so as to switch a jet flow speed of the high-pressure gaseous fuel injected through the injection hole between a subsonic speed and a supersonic speed.

2. The fuel injection apparatus according to claim 1, wherein the nozzle needle is configured to change the sac chamber pressure so as to switch the jet flow speed to the subsonic speed when a lift height of the nozzle needle is below a threshold height, and to the supersonic speed when the lift height of the nozzle needle is the threshold height or greater.

3. The fuel injection apparatus according to claim 1, wherein:
the injection hole further has an inlet portion with a smoothly convergent inner surface as coming from an inlet end of the injection hole to a position narrowest portion of the injection hole; and
the outlet portion has a tapered shape as coming closer to the outlet end thereof.

4. The fuel injection apparatus according to claim 1, wherein a cross-sectional area of the outlet end of the injection hole is set in a range of 2 times to 6 times of a minimum cross-sectional area of the injection hole.

5. The fuel injection apparatus according to claim 1, wherein a divergent angle of the inner surface of the outlet portion is set in a range of 5 degrees to 15 degrees.

6. The fuel injection apparatus according to claim 1, wherein the driving portion includes:
a control chamber that accumulates hydraulic liquid therein so as to exert a backpressure onto the nozzle needle;
a hydraulic liquid supply passage that supplies the hydraulic liquid into the control chamber; and
an electric switching valve that controls an inflow of the hydraulic liquid into the control chamber and an outflow of the hydraulic liquid out of the control chamber.
